(19) United States
(12) Patent Application Publication
(10) Pub. No.: US 2025/0219908 A1
(43) Pub. Date: Jul. 3, 2025

(54) DATA ANALYTICS AT SERVICE ENABLEMENT LAYER

(71) Applicant: CONVIDA WIRELESS, LLC, Wilmington, DE (US)

(72) Inventors: Lu LIU, Conshohocken, PA (US); Dale SEED, Allentown, PA (US); Quang LY, North Wales, PA (US); Catalina MLADIN, Hatboro, PA (US)

(21) Appl. No.: 18/850,357

(22) PCT Filed: Mar. 27, 2023
(86) PCT No.: PCT/US2023/016390

§ 371 Date: Sep. 24, 2024

Related U.S. Application Data
(60) Provisional application No. 63/324,482, filed on Mar. 28, 2022.

(51) Int. Cl. H04L 41/14

(52) U.S. Cl. CPC H04L 41/14

(57) ABSTRACT

Provided herein are various methods, apparatus, and systems for providing a service enablement layer analytics service in a cellular network, such as at the 3GPP service enabler layer. For example, an apparatus may receive, from an analytics service consumer, a service enablement layer data analytics request, wherein the request includes requirements of the analytics service, determine based on the service enablement layer analytics request, to collect data from a service layer server and/or a service layer client, generate analytics result based on the received server-side data, the received client-side data and the requirements of the analytics service, send, to the analytics service consumer, and perform actions or trigger actions to be performed based on the analytics results.

### CROSS-REFERENCE TO RELATED APPLICATIONS

This application claims the benefit of, and incorporates herein by reference, U.S. Provisional Application No. 63/324,482, titled “Data Analytics at Service Enablement Layer,” filed Mar. 28, 2022.

### BACKGROUND

In the 5G Core (5GC), data analytics services are provided to support network and management data analytics. Currently, data analytics services layered on top of 5GC, which supports different vertical scenarios, have not yet been defined. In order to support end-to-end service for the application specific layer to collect data and generate analytics related to the vertical application layer and service enabler layer, further data analytics services are required.

Moreover, data analytics services may also be needed by the service enabler layer itself, which could utilize the statistics and predictions to make decisions or trigger actions to optimize the enablement services or vertical applications. Particularly, the data analytics services at the service enablement layer can support collecting data and generating statistics and predictions related to application performance and coverage, user presence, user group, network resource utilization, edge application server (EAS), edge enabler server (EES), edge data network (EDN), network slice, network exposure, and off-network connections.

### SUMMARY

Described herein are methods, apparatus, and systems for providing a service enablement layer analytics service in a cellular network, such as at the 3GPP service enabler layer, which address the shortcomings discussed above. For example, an apparatus such as an ADAE server, which is either standalone or a capability of a SEAL server or an EES, or an ADAE client, which is either standalone or a capability of a SEAL server or an EEC, may receive, from an analytics service consumer, a service enablement layer data analytics request, wherein the request includes requirements of the analytics service. The apparatus may determine based on the service enablement layer analytics request, to collect data from a service layer server. The apparatus may send, to the determined service layer server, a request to collect server-side service enablement layer data related to the service enablement layer analytics request. The apparatus may receive, from the determined service layer server, the server-side service enablement layer data related to the service enablement layer data analytics request. The apparatus may determine, based on the service enablement layer analytics request, to collect data from a service layer client. The apparatus may send, to the determined service layer client, a request to collect client-side service enablement layer data related to the service enablement layer analytics. The apparatus may receive, from the determined service layer client, the client-side service enablement layer data related to the service enablement layer data analytics request. The apparatus may generate analytics result based on the received server-side data, the received client-side data and the requirements of the analytics service. The apparatus may send, to the analytics service consumer, a response indicating the analytics result, based on the analytics results, perform actions at the service enabler layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1A shows an example of the on-network functional model for an Application Data Analytics Enablement architecture;

FIG. 1B shows an example off-network functional model for an Application Data Analytics Enablement architecture;

FIG. 2 shows an example of an Application Data Analytics Enablement service discovery and request;

FIG. 3 shows an example of a server-side initiated data analytics request;

FIG. 4 shows an example of a client-side initiated data analytics request;

FIG. 5 shows an example of a procedure enabling off-network functionality;

FIG. 6 shows an example of Graphical User Interface to request Application Data Analytics Enablement service and to view the analytics result;

FIG. 7A illustrates an example communications system in which the methods and apparatuses described and claimed herein may be embodied;

FIG. 7B is a block diagram of an example apparatus or device configured for wireless communications;

FIG. 7C is a system diagram of an example radio access network (RAN) and core network;

FIG. 7D is a system diagram of another example RAN and core network;

FIG. 7E is a system diagram of another example RAN and core network;

FIG. 7F is a block diagram of an example computing system; and

FIG. 7G is a block diagram of another example communications system.

### DETAILED DESCRIPTION

Described herein are methods, apparatus, and systems for enabling a data analytics service at the 3GPP service enabler layer, which address the shortcomings discussed above. For example, an ADAE server, which is either standalone or a capability of a SEAL server or an EES, may receive a data analytics request, subscribe to other analytics functions in the system for data and/or analytics results that are of interest to the ADAE server or its client, receive input data from the vertical application layer, the service enabler layer, 5GC via monitoring events, 5GC via interactions with NWDAF, and/or the OAM system, generate data analytics results, send a response to the requestor, and perform actions or trigger actions to be performed based on the analytics results.

An ADAE client, which is either standalone or a capability of a SEAL server or an EEC, may be provided. For example, the ADEA client may receive a data analytics request, receive input data from the vertical application layer, the service enabler layer, other ADAE clients, and/or the modem, initiate data analytics request to the ADAE server, generate data analytics results, send a response to the requestor, and based on the analytics results, perform actions at the service enabler layer.

Methods and apparatuses are described herein for support of redundant transport in a cellular system at an application layer.

The following abbreviations may be used herein:

| 3GPP | 3^{rd} Generation Partnership Program |
|---|---|
| ACR | Application Context Relocation |
| ADAE | Application Data Analytics Enablement |
| AF | Application Function |
| EAS | Edge Application Server |
| ECS | Edge Configuration Server |
| EDN | Edge Data Network |
| EEC | Edge Enabler Client |
| EES | Edge Enabler Server |
| NWDAF | Network Data Analytics Function |
| OAM | Operations, Administration, and Management |
| QoS | Quality of Service |
| SEAL | Service Enabler Architecture Layer |
| UE | User Equipment |
| VAL | Vertical Application Layer |

An ADAE server, which is either standalone or may have the capability of a SEAL server or an EES server, may receive a data analytics request. The requestor may be an application server, like a VAL server or EAS sever, an enabler server, like a SEAL server, an EES server, or an ECS server, a vertical application client, or an enabler client. The request may be forwarded by the ADAE server by the ADAE client.

The request may include target(s) of the analytics reporting, such as UE ID, UE group ID, application server or client ID, and/or enabler server or client ID, filter information, such as area of interest, and or application of interest, required analytics target period, data schema of input data, required operations, such as average, max, min, and/or comparing to a threshold, required or preferred level of accuracy, required or preferred order of results, required or preferred granularity of information, notification correlation ID, such as for subscription, or notification endpoint address, etc.

The received request may be further compared with an existing data analytics instance. If an existing instance with the same analytics type or target is found, the requests may be consolidated or rejected.

The ADAE server may then subscribe to other analytics functions in the system, such as NWDAF or OAM, for data and/or analytics results that are of interest to the ADAE server or its clients. The ADAE server may then receive input data from the vertical application layer, the service enabler layer, 5GC via monitoring events, 5GC via interactions with NWDAF, or the OAM system.

The input data may be received in a notification message responsive to a data collection or subscription request sent by the ADAE server or via a separate request received by the ADAE server. The input data may originate from a vertical application client and/or an enabler client and forwarded to the ADAE server by the ADAE client.

The input data may be received from a vertical application server, client, or EAS, which may include application server or client profile, such as type, schedule, service area, service KPIs, or requirements, performance indicators of the application server, such as RTT for the server, jitter, throughput, PER, load of server, number of connections, etc., or application session, such as RTT for the session, jitter, throughput, PER.

The input data may be received from a SEAL server/client, which may include location information report, group information, such as group member or group formation, configuration information, such as VAL UE configuration data, or VAL user profile, network resource information, such as resource adaptation, or MBMS status, network slice configuration and adaptation, etc.

The input data may be received from an EES/EEC/ECS, which may include EES profile, EEC context, such as registration information, configuration or provisioning information, ACR management events, resources or load of the edge platform, etc. The input data is received from 5GC and may include analytics data from NWDAF via monitoring events, 5GC via interactions with NWDAF, of the OAM system.

The ADAE server may then generate data analytics results, which may be derived locally at the ADAE server or generated with the assistance of a third-party service. The ADAE server may then send a response to the requestor, which may be sent directly to the requesting server.

The response may be sent to the notification endpoint specified in the request or forwarded to the requesting client by the ADAE client. The response may include analytics result of the target application, such as predicted schedule, predicted availability based on predicted service area overlapping, statistics or prediction of server performance, such as RTT for the server, jitter, average or peak throughput, PER, load of server, number of connections, etc., and/or statistics/prediction of session performance, such as RTT for the session, jitter, throughput, PER.

The response may include analytics result of the target SEAL service, such as statistics/prediction of location information, group information, such as a new member joining the group or changing of group size, configuration information, network resource information, network slice configuration and adaptation, etc. The response may include analytics result of the target edge enabler layer, such as statistics or prediction of edge platform load or performance, failure, service availability, edge resource usage, service continuity planning, such as predicted target EES or EAS, or timing of ACR, etc.

The ADAE server may then perform actions or trigger actions to be performed based on the analytics results. The actions at the SEAL layer may include updating location reporting configuration, triggering location reporting, updating group configuration, creating group, updating group member, updating UE configuration, triggering network resource adaptation/modification, triggering network slice adaptation, updating network slice configuration, etc.

The actions at the edge enabler layer may include updating provisioning configuration, triggering EEC, EES registration, deregistration, triggering or updating service continuity planning, triggering or updating ACR, triggering dynamic EAS instantiation, etc.

An ADAE client, which is either standalone or part of a SEAL client or an EEC, may receive a data analytics request. The requestor may be an application server, such as a VAL client, an enabler server, such as a SEAL client or an EEC, another ADAE client. Where the request is forwarded to the ADAE client by the ADAE server, the requestor may be an application server, such as a VAL server or an EAS, or an enabler server, such as a SEAL server, an EES, or an ECS. The request may be forwarded to the ADAE server.

The request may include target(s) of the analytics reporting, such as UE ID, UE group ID, application server or client ID, and/or enabler server or client ID, filter information, such as area of interest, and or application of interest, required analytics target period, data schema of input data, required operations, such as average, max, min, and/or comparing to a threshold, required or preferred level of accuracy, required or preferred order of results, required or preferred granularity of information, notification correlation ID, such as for subscription, or notification endpoint address, etc. The received request may be further compared with an existing data analytics instance. If an existing instance with the same analytics type or target is found, the requests may be consolidated or rejected.

The ADAE client may then receive input data from the vertical application layer, the service enabler layer, other ADAE clients, and/or the modem. The input data may include application server/client profile, such as type, schedule, service area, service KPIs, or requirements, performance indicators of the application server, such as RTT for the server, jitter, throughput, PER, load of server, and/or number of connections, or an application session, such as RTT for the session, jitter, throughput, and/or PER. The input data may be received in a notification message responsive to data collection or subscription request sent by the ADAE client. The input data may be forwarded to the ADAE server.

The ADAE client may then initiate a data analytics request to the ADAE server. The ADAE client may then generate data analytics results, which may be derived locally at the ADAE client, generated with assistance of a third part service, and/or obtained from the ADAE server. The ADAE client may then send a response to the requestor, which may be sent directly to the requesting server.

The response may include analytics result of the target application, such as predicted schedule, predicted availability based on predicted service area overlapping, statistics/prediction of server performance, such as RTT for the server, jitter, average or peak throughput, PER, load of server, number of connections, etc., and/or statistics/prediction of session performance, such as RTT for the session, jitter, throughput, PER.

The response may include analytics result of the target SEAL service, such as statistics/prediction of location information, group information, such as a new member joining the group or changing of group size, configuration information, network resource information, network slice configuration and adaptation, etc. The response may include analytics result of the target edge enabler layer, such as statistics or prediction of edge platform load or performance, failure, service availability, edge resource usage, service continuity planning, such as predicted target EES or EAS, or timing of ACR, etc.

The ADAE client may then perform actions or trigger actions to be performed based on the analytics results.

The actions at the SEAL layer may include updating location reporting configuration, triggering location reporting, updating group configuration, creating group, updating group member, updating UE configuration, triggering network resource adaptation/modification, triggering network slice adaptation, updating network slice configuration, etc. The actions at the edge enabler layer may include updating provisioning configuration, triggering EEC, EES registration, deregistration, triggering or updating service continuity planning, triggering or updating ACR, triggering dynamic EAS instantiation, etc.

### Functional Model

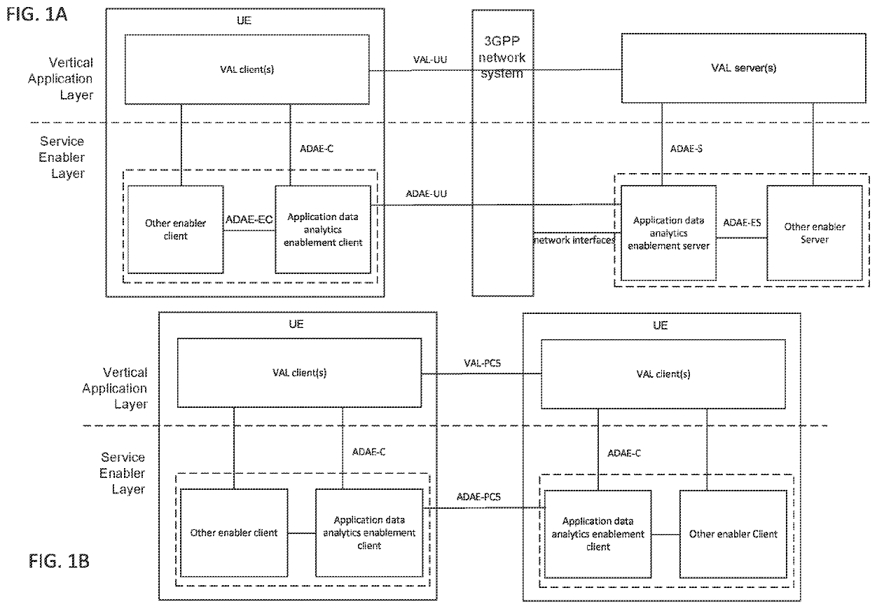

FIG. 1A shows an example of the on-network functional model for the ADAE architecture. Examples of other enabler clients are SEAL and Edge Enabler clients, and examples of other enabler servers are SEAL and Edge Enabler Servers. An ADAE server may communicate with another ADAE server.

FIG. 1B shows an example of the off-network functional model for the ADAE architecture.

### Functional Entities Description

The ADAE server in FIG. 1A may provide the server-side functionalities of the ADAE service, including receiving data analytics request, collecting input data from the vertical application layer and other service enabler servers, and generating output analytics. The ADAE server may supports interaction with the ADAE client, VAL server(s) and other entities in the 5G system. The ADAE server may also supports interactions with another ADAE server in distributed deployments.

The ADAE client in FIGS. 1A and 1B may provide the client-side functionalities of the ADAE service and may act as the application client for the ADAE functions. The ADAE client may support interactions with the ADAE server and VAL client(s). The ADAE client may also support interactions with other ADAE clients between two UEs.

The VAL server in FIG. 1A may provide the server-side functionalities corresponding to the vertical applications. The VAL server may support interactions with the ADAE server and other service enabler layer servers. The VAL server may act as the consumer of the ADAE service and initiate data analytics request. The VAL server may also provide input data to the ADAE server to support the ADAE service.

The VAL client in FIGS. 1A and 1B may provide the client-side functionalities corresponding to the vertical applications. The VAL client supports interactions with the ADAE client and other service enabler layer clients. The VAL client may act as the consumer of the ADAE service and initiate data analytics request. The VAL client may also provide input data to the ADAE client to support the ADAE service.

In FIG. 1A, a service enabler layer server other than the ADAE server may act as the consumer of the ADAE service and initiate data analytics request. The enabler server may also provide input data to the ADAE server to support the ADAE service. For example, an enabler server may be a SEAL server, such as a location management server, group management server, or network resource management server, an EES, an ECS, etc.

In FIGS. 1A and 1B, a service enabler layer client other than the ADAE client may act as the consumer of the ADAE service and initiate data analytics request. The enabler client may also provide input data to the ADAE client to support the ADAE service. For example, an enabler client may be a SEAL client, such as a location management client, group management client, or network resource management client, an EEC, etc.

### Reference Points Description

In FIG. 1A, the ADAE-UU reference point may support interactions between an ADAE server and the corresponding ADAE client, such as sending or forwarding data analytics request, sending data collection request or response, sharing input data or output analytics.

In FIG. 1A, the ADAE-S reference point may support interactions between an ADAE server and the VAL server(s), such as sending or receiving data analytics request, collecting input data, sending or receiving data analytics response with output analytics.

In FIGS. 1A and 1B, the ADAE-C reference point may support interactions between an ADAE client and the VAL client(s), such as sending or receiving data analytics request, collecting input data, sending or receiving data analytics response with output analytics.

In FIG. 1A, the ADAE-ES reference point may support interactions between an ADAE server and other service enabler layer server(s), such as sending or receiving data analytics request, collecting input data, sending or receiving data analytics response with output analytics.

In FIG. 1A, the ADAE-EC reference point may support interactions between an ADAE client and other service enabler layer client(s), such as sending or receiving data analytics request, collecting input data, sending or receiving data analytics response with output analytics.

In FIG. 1B, the ADAE-PC5 reference point may support interactions between ADAE clients on two UEs, such as sending or receiving data analytics request, sending or receiving data analytics response with output analytics.

### ADAE Service Exposure

An ADAE service consumer may request ADAE service by sending a one-time request or a subscription request to the ADAE server or client.

In the ADAE service request or subscription request, the service customer may provide the following information:

| Information | Description |
|---|---|
| Consumer ID | Identifier of the service consumer. |
| Analytics type ID | Identifies the type of requested analytics, e.g., application analytics, |
| | EAS analytics, EDN analytics, network slice analytics, etc. May |
| | also specify whether the requested analytics service is statistics or |
| | prediction or both. |
| Analytics targets | Identifies the objects for which the analytics information is |
| | requested, e.g., one or more specific VAL users or UEs, all VAL |
| | users or UEs, one or more specific applications, all applications |
| | (serving an UE), an EES, an EAS, an EDN, a network slice, etc. |
| Data schema | Schema definition specifying the format of the input data that the |
| | ADAE service is to process and perform analytic operation upon |
| | and/or the format of the output data that the ADAE service is to |
| | generate from the analytics operation. |
| Analytics filter | Specifies any filter information that applies to the analytics service, |
| | e.g., area of interest, UE (group) of interest, application of interest, |
| | events of interests, etc. |
| Analytics target period | Specifies the time period over which the statistics or predictions are |
| | requested. For example, the request is for statistics during the “last |
| | 24 hours”, or for predictions of the “next week”. |
| | If the required analytics is for statistics, then the analytics target |
| | period could a time period in the past, in the present, or in the |
| | future. If the required analytics is for predictions, then the analytics |
| | target period should be a time period in the future. |
| Data collection period | Specifies the time interval/window during which input data is |
| | collected. |
| | If the required analytics is for statistics, then the data collection |
| | period may be the same as the analytics target period. If the |
| | required analytics is for prediction, then the data collection period |
| | should be a time period ahead of the analytics target period. |
| | If data collection period is not specified in the request, the ADAE |
| | service may determine when to collect input data based on the other |
| | information in the request. |
| Analytics operation | Specifies analytics operation that the ADAE server is to perform |
| | (e.g., time series, running average, max/min value, comparing with |
| | threshold, etc.). May also specify one or more data sets for the |
| | operation to be applied to. Each dataset could be defined as data |
| | that is associated with the one or more specified targets such as the |
| | operations performed by the analytics objects, events generated by |
| | the objects, etc. |
| Analytics requirement | Specifies preferences and/or requirements of the requested |
| | analytics, e.g., required number of data samples, required order of |
| | results, required size of dataset, preferred accuracy or granularity of |
| | the analytic result, etc. |
| Reporting targets | Identifiers or endpoint address of where the analytics results should |
| | be sent to. It could be the requestor, the service consumer, a data |
| | repository, etc. |
| Conditional Actions | Specifies one or more actions triggered and/or performed by the |
| | ADAE service contingent upon one or more specified conditions. |
| | Where a condition is an expression having dependencies on |
| | analytic operations performed by the ADAE service. |
| | For example, if EAS XYZ load >90%, then trigger ACR. |

After receiving the request, the ADAE client or server may generate a service instance for the requested data analytics service. The instance may be associated with a specific analytics type and/or a specific analytics target. Information of the instance is maintained in an ADAE service instance profile such as the following:

| Information | Description |
|---|---|
| Instance ID | Identifier of the service instance. |
| Analytics type ID | Identifies the type of data analytics of this instance, e.g., UE |
| | location, network resource management, EAS load, EDN load, |
| | network slice, etc. May also specify whether the analytics service is |
| | for statistics or prediction. |
| Analytic target | Identifies the object for which the analytics information is provided |
| | by this instance, e.g., identifier(s) of a specific VAL user or UE, an |
| | EAS, an EDN, a network slice, etc. |
| Supported configuration | Specifies the limitations of service supported by this instance, such |
| | as supported analytics target period, data collection period, |
| | supported operations, accuracy of result, granularity of result. |
| Associated instance | A list of identifiers of the data analytics instances that are |
| | associated with this service profile. |
| Service consumer | Identifiers of consumers associated with this instance. |

The service instance profile may be made available to the potential consumers, such as the service enabler layer and/or the vertical specific applications, through advertising and discovery procedures.

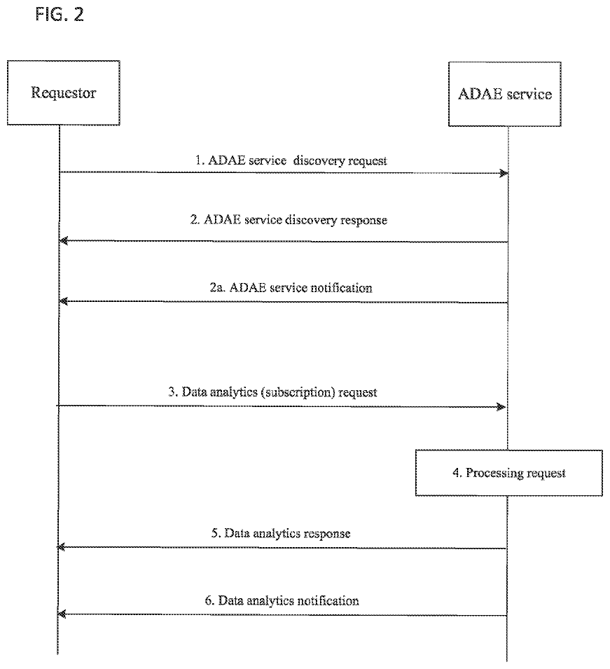

FIG. 2 shows an example of an ADAE service discovery and request. The following steps are directed to FIG. 2.

In step 1, which is optional, the requestor may send a discovery request to the ADAE service. The discovery request may include a filter specifying the type of data analytics and/or the target of the analytics. Alternatively, the request may indicate that the requestor subscribes to notifications of data analytics instance profiles available at the ADAE service.

In step 2, which is optional, the ADAE service may send a response to the requestor, including the discovered service instance(s).

In step 2A, if in step 1 the requestor subscribes to notifications of data analytics instance profiles, when new profiles get configured at the ADAE service, a notification may be sent to the requestor.

In step 3, the requestor may send a data analytics (subscription) request to the ADAE service, including information specified in the tables above. If the request is following the discovery process, then the requestor may include the discovered/selected service instance ID in the request.

In step 4, the ADAE service may processes the request. The ADAE service may create or update a service instance profile accordingly. The received request could be compared with an existing data analytics instance. If an existing instance with the same analytics type or target is found, the requests may be consolidated or rejected.

In step 5, the ADAE service may send a response to the requestor.

In step 6, if the request defined in step 3 is a subscription request, the ADAE service may send one or more notifications to the requestor and/or to other specified targets. The notifications may contain the results of the analytic operations performed by the ADAE service and/or additional information such as the occurrence of events related to the ADAE service, such as fault conditions, lifecycle management events, etc., or actions performed by the ADAE service based on the request, such as triggering OAM actions based on analytic results, triggering service enabler actions based on analytic results, triggering VAL client and/or VAL server actions based on analytic results etc.

Interactions with NWDAF

An ADAE Server may provide analytics services to NFs in the 5GCN. For example to NWDAF via NEF, however, similar interactions may be envisioned directly for other authorized NFs. For example, the NEF may expose a Nnef_AnalyticsContainer service allowing CN-external parties to provide via ADAE Server application-level analytics which can be used in 5GS. Corresponding Nnef_AnalyticsContainer_Create/Update/Delete/Get/Notify operations may be provided.

For the Nnef_AnalyticsContainer_Create requester, such as an ADAE Server, stores application-level analytics parameters in the NWDAF or UDR via the NEF. The inputs may include ADAE Service Descriptor, such as External Application Identifier, target identifiers, and/or analytics type.

The target identified may be UEs or group of UEs, such as IP address or UE if available, GPSI if available, and/or External Group Identifier if available, App IDs, Service Provider IDs, geographical area, such as TAI, DNN or EDN identifiers, etc. The parameter may allow the 5GCN to determine to which 5GS entity the analytics apply to.

The response to the Nnef_AnalyticsContainer_Create request may indicate to the ADAE Server whether the NWDAF wants to subscribe to notification of the indicated analytics type for the indicated target(s). If a NWDAF subscription is indicated, the response may also provide information about the notification destination.

Nnef_AnalyticsContainer_Create may be defined such that for each analytics type the analytics are specified parameters are specified in the message, or the analytics may be specified as an opaque container. The container option may allow for custom analytics inputs to be provided as well.

The ADAE Server may provide notifications corresponding to the subscribed analytics using the Notify operation. Alternatively, ADAE interactions with NWDAF may be envisioned in which the NEF or NWDAF, directly or via NEF, may subscribe directly to ADAE, such as if NF in 5GS employ ADAE APIs. Equivalent interactions may be envisioned for the ADAE to OAM interactions.

### ADAE Service Procedures

After receiving the service request, the ADAE service may collect input data and may generate requested output analytics according to the request. This section describes the common procedures of ADAE service. Details of information exchanged, and actions taken in each step may vary depending on the different analytics types.

### On-Network Server-Client Scenario

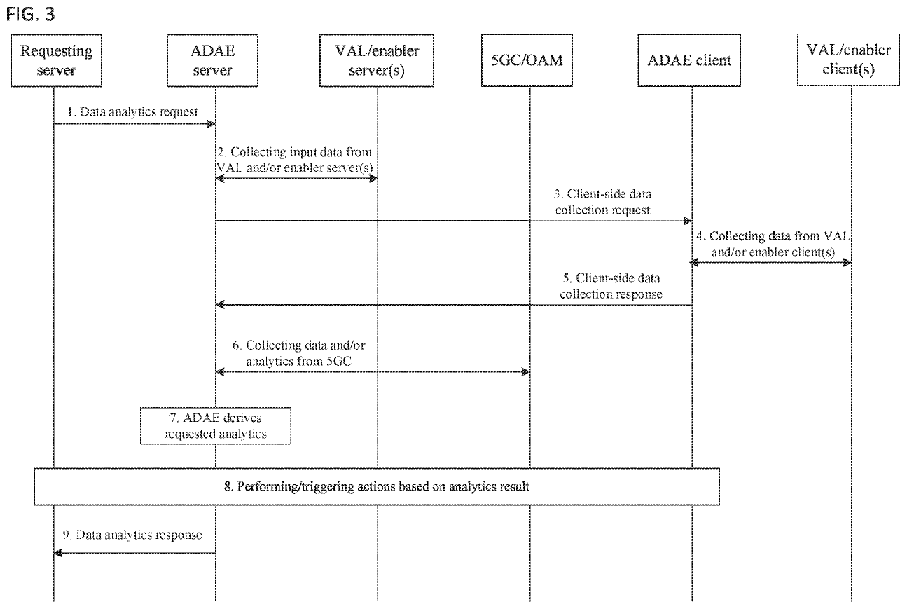

FIG. 3 shows an example procedure for providing a service enablement layer analytics service in a cellular network, such as a 3GPP system, when the data analytics request is initiated at the server side, including processing at an on-network ADAE client and sending the result to the ADAE server. The following steps are directed to FIG. 3.

In step 1, the requesting server, or any analytics service consumer, may send a data analytics request, such as a service enablement layer data analytics request, to the ADAE server. Details of information included in the request are detailed in the tables above, but may also include requirements of the analytics service. The requesting server could be a VAL server, an enabler layer server, such as a SEAL server, or an EES, an EAS, other analytics function in the 5G system, such as NWDAF, etc.

In step 2, based on the request, the ADAE server may determine to collect input data from other servers in the system, such as a vertical application server, a SEAL server, an EES/EAS/ECS, etc. The input data may be collected by initiating a data collection or subscription request to the corresponding server and may be received by the ADAE server in a response or notification message responsive to the data collection request. The input data may be collected from the vertical application layer, SEAL layer, or Edge enabler layer. The input data may be collected by sending a request to collect server-side service enablement layer data related to the service enablement layer analytics request to the server determined to collect data from, and receiving, from the determined server, the server-side service enablement layer data related to the service enablement layer data analytics request.

Input data collected from vertical application layer may include application server/client profile, such as type, schedule, service area, service KPIs, requirements, etc., performance indicators of the application server, such as RTT for the server, jitter, throughput, PER, load of server, number of connections, etc., or application session, such as RTT for the session, jitter, throughput, PER.

Input data collected from SEAL layer may include location information report, such as data indicative of being from location management server, VAL user or UE group information, such as list of group members, group formation information, or from group management server, configuration information, such as VAL UE configuration data, VAL user profile, or from configuration server, network resource information, such as resource adaptation, MBMS status, or from network resource management server, network slice configuration and adaptation information, such as from network slice capability enablement server, etc.

Input data collected from edge enabler layer may include EES profile, EEC context, such as registration information, edge configuration or provisioning information, ACR management events, resource utilization, or load of the edge platform, etc.

In step 3, if the requested analytics requires client-side input data, the ADAE server sends a data collection request to the corresponding ADAE client. The request may specify what input data may be required from the client-side. The request for client-side data may be determined based on the service enablement layer analytics request.

In step 4, after receiving the data collection request from the ADAE server, the ADAE client may collect client-side input data from VAL clients, enabler layer clients, such as a SEAL client, or EEC, other ADAE clients, and the modem. Client-side input data may include information as described in step 2.

In step 5, the collected client-side input data may be sent to the ADAE server.

In step 6, the ADAE server may further collect input data and/or request for analytics service from other analytics functions in the system, such as NWDAF or OAM. For example, the ADAE server may collect input data from 5GC via monitoring events or via interactions with NWDAF, receive input data from OAM system, receive analytics result from NWDAF by subscription, etc.

In step 7, based on the collected input data, the ADAE server may derive the analytics result. The analytics results may be derived based on the server-side data, the client-side data, and the requirements of the analytics service. The analytics result may include:
Analytics result of the target application, such as predicted schedule, predicted availability based on predicted service area overlapping, statistics or prediction of server performance, such as RTT for the server, jitter, average or peak throughput, PER, load of server, number of connections, etc., statistics or prediction of session performance, such as RTT for the session, jitter, throughput, PER.

Analytics result of the target SEAL service, such as statistics/prediction of location information, group information, such as new member joining the group, or changing of group size, configuration information, network resource information, network slice configuration and adaptation, etc.

Analytics result of the target edge enabler layer, such as statistics/prediction of edge platform load or performance, failure, service availability, edge resource usage, service continuity planning, such as predicted target EES or EAS, or timing of ACR, etc.

Analytics result of the target VAL users or UE, or group of VAL users or UEs such as information regarding distribution, density, or membership of UEs in a certain location or group.

Analytics result for a target DN, EDN or network slice thereof such as loading analytics. For example, the number of UEs, VAL users and/or sessions active in an DN, EDN or network slice.

In step 8, the ADAE server may perform actions or trigger actions to be performed, such as by sending a request to the corresponding entity, based on the analytics result. The actions may include:
Actions at the SEAL layer, such as updating location reporting configuration, triggering location reporting, updating group configuration, creating group, updating group member, updating UE configuration, triggering network resource adaptation or modification, triggering network slice adaptation, updating network slice configuration, etc.

Actions at the edge enabler layer, such as updating provisioning configuration, triggering EEC or EES registration or deregistration, triggering or updating service continuity planning, triggering or updating ACR, triggering dynamic EAS instantiation, etc.

In step 9, the ADAE server may send a response or notification regarding the analytics result. The response or notification may be sent to the requesting server and/or other targets as specified in the reporting targets in the tables above.

### On-Network Client-Server Scenario

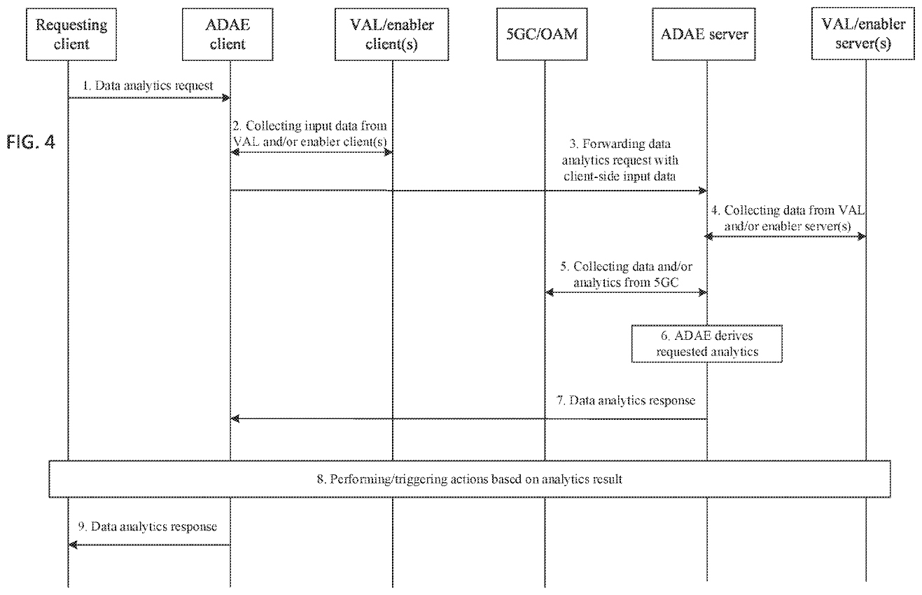

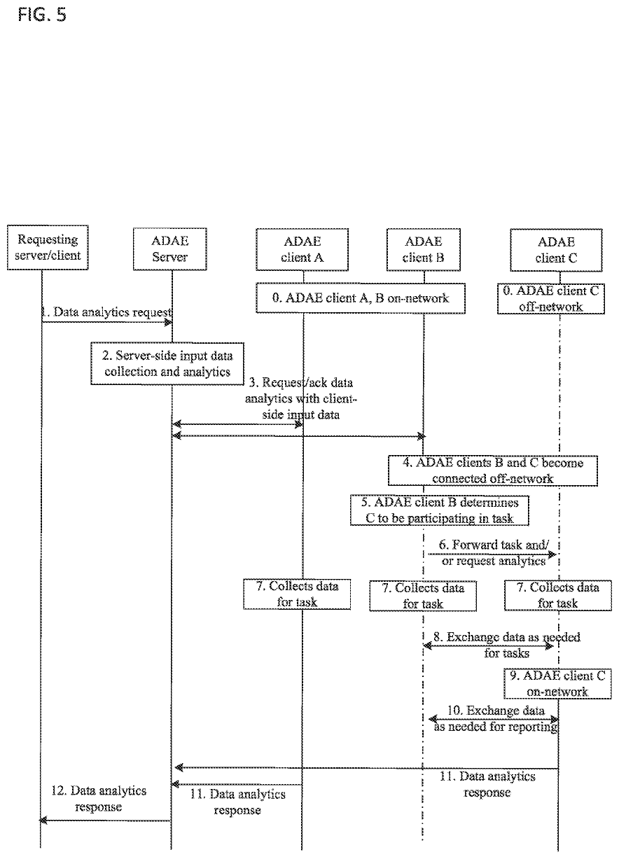

FIG. 4 shows an example procedure when the data analytics request is initiated at the client side, including processing at the ADAE server and sending the result to the on-network ADAE client. The following steps are directed to FIG. 4.

In step 1, the requesting client nay send a data analytics request to the ADAE client. Details of information included in the request are shown in tables above Error! Reference source not found. The requesting client may be a VAL client, an enabler layer client, such as a SEAL client or an EEC, etc. The ADAE client may also initiate a data analytics request by itself, in which case step 1 is skipped.

In step 2, based on the request, the ADAE client may collect client-side input data in the system. The ADAE client may collect input data from the VAL clients, enabler layer clients, other ADAE clients, and the modem. Client-side input data may include information as described in step 2 of FIG. 3.

In step 3, the ADAE client may forward or send the data analytics request to the ADAE server with the collected client-side input data.

In step 4, based on the request, the ADAE server may collect server-side input data from other servers in the system, such as in step 2 of FIG. 3.

In step 5, the ADAE server may further collect input data and/or request for analytics service from other analytics functions in the system, such as in step 6 of FIG. 3 Error!

### Reference Source not Found.

In step 6, based on the collected input data, the ADAE server may derive the analytics result, such as in step 7 of FIG. 3.

In step 7, the ADAE server may send a response to the ADAE client with the analytics result.

In step 8, the ADAE server performs or triggers action(s) accordingly, such as in step 8 of FIG. 3. Alternatively, the ADAE server may send a request to the ADAE client to perform or trigger the desired action.

In step 9, the ADAE client may send a response or notification regarding the analytics result. The response or notification may be sent to the requesting client and/or other targets as specified in the reporting targets in the tables above.

### Enabling Off-Network Functionality

FIG. 5 shows an example procedure for processing an analytics request using ADAE clients which are off-network. The analytics request may be initiated by either a client or server requester and may distributed via the ADAE server. The following steps are directed to FIG. 5.

In step 1, the requester client or server may send a data analytics request to the ADAE Server. This may be a request initiated though another ADAE client, which may be ultimately forwarded to the ADAE Server. Details of information included in the request are shown in the tables above Error! Reference source not found.

In step 2, the ADAE Server may perform server-side input data collection and analytics.

In step 3, the ADAE server may send the data analytics task to the ADAE clients with the collected server-side input data. The server may include information about ADAE clients that are participating in the task in the message sent to the clients. For ADAE clients hosted by on-network UEs, such as Client A in FIG. 5, step 7 may be followed after step 3.

In step 4, the UE Client B and C may connect and operate off-network.

In step 5, Client B may identify that Client C is participating in the analytics task and determines to forward the task.

In step 6, Client B may forward the analytics task corresponding to the Client C to Client C.

In step 7, ADAE Clients may perform the necessary analytics tasks.

In step 8, the off-network ADAE clients may optionally perform inter-ADAE Client signaling necessary for performing the ADAE tasks. The signaling may involve data exchange, as well as data operation control. For example, one ADAE Client may trigger the other to refresh data, re-start averaging, etc. based on its own processing.

In step 9, a previously off-network ADAE client, such as Client C, may come on-line and is connected to the ADAE Server.

In step 10, if UE hosting Client C comes on-line, it may check if Client B has unreported data to send to the ADAE Server. If it does, it may collect it and may send it along with its report.

In step 11, the ADAE clients may send analytics reports to the ADAE Server. This may include reports from off-network clients. Alternatively, off-network clients may provide their analytic reports when on-line.

In step 12, the ADAE Server may process the reports and may provide the analytics response to the requester.

The example shown in FIG. 5, describes Client C coming on-line first. Therefore, Client C is shown collecting information from itself and B and communicates it to the ADAE Server. Many equivalent and alternatives can be envisioned. For example, in some off-network deployments certain UEs may act as relays. This may cause Client B to get on and off-network. Similarly, ADAE Client C may be on a non-3GPP device, for example, a device that can be identified in the network, but not have 3GPP connectivity. Both of these examples would use similar procedures.

Additionally, step 6 to 11 may also apply to other client-to-client communication and is not limited to off-network scenario.

### Application Analytics

Application performance analytics may be used to obtain information about the performance and/or function of a vertical application client or server or an edge application client or server.

When requesting application analytics, in addition to the information in the tables above, the requestor may specify the identifier of the target application in the request. Furthermore, the requestor may specify what performance and/or functional indicators are required, such as performance indicators such as RTT, jitter, throughput, PER, or functional operation such as number or distribution of application client requests issued to an application server. If not specified, all available indicators may be applied.

The input data for application performance analytics may be collected from the vertical application layer (VAL server and/or client), 5GC, OAM, as defined in table below:

| Information | Description |
|---|---|
| Application ID | Identifier of the requested application. |
| UE (group) ID | Specifies the identifier(s) of the VAL user(s) or UE(s) (and the |
| | associated group ID) to which the analytics may apply. |
| Application indicators | Performance or functional indicators that are collected for the target |
| | application. |
| >Timestamp | A timestamp when the performance data is collected. |
| >Session measurements | Performance and/or functional measurements of the application |
| | session, such as session RTT, jitter, throughput, PER, etc. |
| >Server measurements | Performance and/or functional measurements of the VAL server, |
| | such as server RTT, jitter, throughput, PER, server load, number of |
| | connections to the server, number or distribution of application |
| | client requests issued to the server, etc. |

The output analytics to be exposed by the ADAE may include statistics or predictions as defined in the table below:

| Information | Description |
|---|---|
| Application ID | Identifier of the requested application. |
| UE (group) ID | The identifier(s) of the VAL user(s) or UE(s) (and the associated |
| | group ID) to which the analytics may apply. |
| List of application | List of observed statistics or predicted analytics of the target |
| analytics (1 . . . max) | application during the analytics target period. Each entry in the list |
| | corresponds to a data analytics result associated with a subset |
| | within the analytics target period. |
| >Analytics target | Time window within the requested analytics target period that the |
| period subset | analytics applies to. |
| >Session analytics | Observed/predicted performance and/or functional indicators of the |
| | application session, such as session RTT, jitter, throughput, PER, |
| | etc. |
| >Server analytics | Observed/predicted performance and/or functional indicators of the |
| | VAL server, such as server RTT, jitter, throughput, PER, server |
| | load, number of connections to the server, number or distribution of |
| | application client requests issued to the server, etc. |
| >Confidence | Confidence of this prediction. |
| (prediction only) | |
| Processed analytics | Other analytics results that are obtained according to the analytics |
| | operations defined in the request, such as average or max/min |
| | throughput, ratio/percentage of time when the measurement is |
| | above/below a threshold, etc. |

The ADAE service may trigger actions based on the output analytics. For example, if a performance degradation is predicted, the ADAE server may send a notification to the affected VAL application so that the latter may take actions proactively, or the ADAE server may send a resource adaptation request that may allocate more resource to the affected application and mitigate the potential impact.

### Application Coverage Analytics

Application coverage analytics may be used to obtain information about distribution or coverage of different types of applications at a certain location.

When requesting application coverage analytics, in addition to the information in tables above, the requestor may also specify the identifier of the target location or service area in the request. If the analytics are related to finding one or more particular types of application in a certain area, the requestor may also need to specify the identifiers of the applications that are to be tracked.

The input data for application coverage analytics may be collected from the vertical application layer, 5GC, OAM, as defined in table below:

| Information | Description |
|---|---|
| Location ID | Identifier of the requested geographical location (range) or service |
| | area. |
| Application ID | Specifies the identifier(s) of the applications or the types of the |
| | applications to which the analytics may apply. |
| Application coverage | Collected information of the distribution or coverage of |
| information | applications at the designated location. |
| >Timestamp | A time stamp when the VAL users or UEs are detected to be |
| | present at the designated location. |
| >Application list | Identifiers of the (types of) applications that are being offered at the |
| | designated location. |
| Service area information | Service area or coverage information of the specified application(s) |
| | or of the applications being offered at the designated location. |

The output analytics to be exposed by the ADAE may include statistics or predictions defined in the table below:

| Information | Description |
|---|---|
| Location ID | Identifier of the requested geographical location (range) or service |
| | area. |
| Application ID | The identifier(s) of the applications or the types of the applications |
| | to which the analytics may apply. |
| List of application | List of observed statistics or predicted analytics during the analytics |
| coverage analytics | target period. Each entry in the list corresponds to a data analytics |
| (1 . . . max) | result associated with a subset within the analytics target period. |
| >Analytics target | Time window within the requested analytics target period that the |
| period subset | analytics applies to. |
| >Application list | Observed/predicted list of (types of) applications offered at the |
| | location. |
| >Application status | Observed/predicted indicator of whether the specified (type of) |
| | application is / will be offered. |
| >Confidence | Confidence of this prediction. |
| (prediction only) | |
| Service area analytics | Observed/predicted service area or coverage information of the |
| | specified application(s) or of the applications offered at the |
| | designated location. |
| Processed analytics | Other analytics results that are obtained according to the analytics |
| | operations defined in the request, such as the average number of |
| | applications available at the location, ratio/percentage of time when |
| | a certain type of application is available, etc. |

The ADAE service may trigger actions based on the output analytics. For example, a service coverage gap may be identified by examining the statistics or predictions of application coverage, which may guide the decision of deployment or instantiation of applications.

### User Presence Analytics

User presence analytics may be used to obtain information about VAL user's or UE's distribution or density at a certain location or track the presence of one or more specified VAL users or UEs.

When requesting User presence analytics, in addition to the information in tables above, the requestor may also specify the identifier of the target location or service area in the request.

If the analytics are related to determining the number of Users at a certain location, “number of Users” may be specified in the request.

If the analytics are related to finding a particular User or Users within a certain group in a certain area, “User presence” may be specified in the request. The requestor also needs to specify the IDs and group ID of VAL users or UEs that are to be tracked.

The input data for User presence analytics may be collected from the vertical application layer, the location management SEAL server, 5GC, OAM, as defined in table below:

| Information | Description |
|---|---|
| Location ID | Identifier of the requested geographical location (range) or service |
| | area. |
| User (group) ID | Specifies the identifier(s) of the VAL user(s) or UE(s) (and the |
| | associated group ID) to which the analytics may apply. |
| User presence | Collected information of the presence and distribution of VAL |
| information | users or UEs at the designated location. |
| >Timestamp | A time stamp when the VAL users or UEs are detected to be |
| | present at the designated location. |
| >User list | Identifiers of the VAL users or UEs that are present at the |
| | designated location. |

The output analytics to be exposed by the ADAE may include statistics or predictions as defined in the table below:

| Information | Description |
|---|---|
| Location ID | Identifier of the requested geographical location (range) or service |
| | area. |
| User (group) ID | The identifier(s) of the VAL user(s) or UE(s) (and the associated |
| | group ID) to which the analytics may apply. |
| List of User presence | List of observed statistics or predicted analytics during the analytics |
| analytics (1 . . . max) | target period. Each entry in the list corresponds to a data analytics |
| | result associated with a subset within the analytics target period. |
| >Analytics target | Time window within the requested analytics target period that the |
| period subset | analytics applies to. |
| >User list | Observed/predicted list of VAL users or UEs present at the |
| | location. |
| >User status | Observed/predicted presence of the specified VAL user(s) or UE(s) |
| | at the location (e.g., an indicator of whether the VAL user or UE |
| | is/will be present). |
| >Number of Users | Observed/predicted number of VAL users or UEs present at the |
| | location. |
| >Confidence | Confidence of this prediction. |
| (prediction only) | |
| Processed analytics | Other analytics results that are obtained according to the analytics |
| | operations defined in the request, such as average number of users |
| | at the location, ratio/percentage of time when the VAL user or UE |
| | is present, etc. |

The ADAE service may trigger actions based on the output analytics. For example, statistics of a User's presence at a certain location can be used to predict the User's route information and shared with the VAL server. If the user density is predicted to exceed a certain threshold at a future time, the service enabler layer may be informed, and edge application servers may be instantiated to offload the surging traffic. Prediction of the UE's presence may also be used to determine schedule or trigger an ACR.

### User Group Analytics

User group analytics may be used to obtain information about VAL user groups or UE groups, as well as to track the group memberships of a certain VAL user or UE.

When requesting User group analytics, in addition to the information in the tables above, the requestor may also specify the identifier of the target group, the target VAL user or UE in the request.

If the analytics are related to determining the number of VAL users or UEs of a group, “group size” may be specified in the request. If the analytics are related to tracking the group membership of a particular VAL user or UE, “user membership” may be specified in the request. The requestor also needs to specify the ID of the VAL user or UE.

The input data for User group analytics may be collected from the vertical application layer, the group management (SEAL) server, 5GC, OAM, as defined in the table below:

| Information | Description |
|---|---|
| Group ID | Identifier of the requested group. |
| User ID | Specifies the identifier(s) of the VAL user(s) or UE(s) to which the |
| | analytics may apply. |
| Group information | Collected information of the target group or user. |
| >Timestamp | A time stamp when the group information is collected. |
| >Member list | Identifiers of the group members (VAL users or UEs). |
| >Membership | An indicator of whether the specified VAL user or UE is a member |
| information | of the group. Optionally, the information may include the |
| | timestamps of when the user/UE joins and leaves the group. |
| >Application ID | List of application IDs that are being used by each of the users in |
| | the group. |

The output analytics to be exposed by the ADAE may include statistics and predictions as defined in the table below:

| Information | Description |
|---|---|
| Group ID | Identifier of the requested group. |
| User ID | The identifier(s) of the VAL user(s) or UE(s) to which the analytics |
| | may apply. |
| List of User group | List of observed statistics or predicted analytics during the analytics |
| analytics (1 . . . max) | target period. Each entry in the list corresponds to a data analytics |
| | result associated with a subset within the analytics target period. |
| >Analytics target | Time window within the requested analytics target period that the |
| period subset | analytics applies to. |
| >Member list | Observed/predicted list of group members (VAL users or UEs). |
| >User membership | Observed/predicted membership of the specified VAL user(s) or |
| | UE(s) in the group (e.g., an indicator of whether the VAL user or |
| | UE is / will be in the group, the timestamps of joining and leaving |
| | the group). |
| >Application usage | Observed/predicted list of application IDs that are being used by |
| | each of the users in the group. |
| >Group size | Observed/predicted number of members (VAL users or UEs) in the |
| | group. |
| >Confidence | Confidence of this prediction. |
| (prediction only) | |
| Processed analytics | Other analytics results that are obtained according to the analytics |
| | operations defined in the request, such as average size of the group, |
| | ratio/percentage of time when the specified VAL user or UE is in |
| | the group, the most popular application in the group, etc. |

The ADAE service may trigger actions based on the output analytics. For example, group management operations may be taken proactively based on the predicted time of when a member may join or leave the group.

The User group analytics result may also be combined with the User presence analytics or other location related analytics to generate location-based group analytics.

### Network Resource Analytics

Network resource analytics may be used to provide information of resource utilization of multicast services during a time period at a particular service area and for a particular group of VAL user or UE.

When requesting network resource analytics, in addition to the information in the tables above, the requestor may also specify the TMGI or other multicast session identifier, VAL user ID or UE ID, and service area identifier in the request.

The input data for network resource analytics may be collected from the network resource management SEAL server, 5GC, OAM, as defined in the table below:

| Information | Description |
|---|---|
| Multicast group | An identifier for the multicast group, such as the TMGI or other |
| identifier | information to identify the multicast session. |
| Service area | Identifier of the service area. |
| Resource information | Collected network resource utilization information. |
| >Timestamp | A timestamp when the network resource information is collected. |
| >Resource utilization | Network resource utilization status. |
| >Service requirement | VAL service requirements for network resources. |
| >QoS information | The QoS information for the multicast session. |

The output analytics to be exposed by the ADAE may include statistics or perform predictions as defied in the table below:

| Information | Description |
|---|---|
| Multicast group | An identifier for the multicast group, such as the TMGI or other |
| identifier | information to identify the multicast session. |
| Service area | Identifier of the service area. |
| List of resource | List of observed statistics or predicted analytics of network |
| utilization analytics | |
| (1 . . . max) | resource utilization during the analytics target period. Each entry in |
| | the list corresponds to a data analytics result associated with a |
| | subset within the analytics target period. |
| >Analytics target | Time window within the requested analytics target period that the |
| period subset | analytics applies to. |
| >Resource utilization | Observed/predicted network resource utilization status. |
| >Server requirements | Observed/predicted service requirements for network resources. |
| >QoS information | The QoS information for the multicast session. |
| >Number of members | Observed/predicted number of members. |
| >Confidence | Confidence of this prediction. |
| (prediction only) | |
| Processed analytics | Other analytics results that are obtained according to the analytics |
| | operations defined in the request. |

### EAS Analytics

EAS analytics may be used to monitor and predict the load and status of an EAS. When requesting EAS analytics, in addition to the information in tables above, the requestor may specify the identifier of the target EAS in the request. The input data for EAS analytics may be collected from the EAS, edge enabler layer, such as the associated EES and/or ECS, other ADAE servers, as defined in the table below:

| Information | Description |
|---|---|
| EAS ID | Identifier of the target EAS. |
| EAS information | Collected information of the target EAS. |
| >Timestamp | A timestamp when the EAS information is collected. |
| >Application ID | Application ID(s) associated with this EAS. |
| >EAS indicators | Information of the EAS load, such as the number of ACs being |
| | served by the EAS, percentage of resource available at the EAS |
| | (compute, graphical compute, memory, storage), connection |
| | bandwidth per AC, response time to service AC requests, time EAS |
| | is available to service AC requests, etc. |
| >EAS status | The status of the EAS (e.g., enabled, disabled, etc.). |

The output analytics to be exposed by the ADAE may include statistics or predictions as defined in the table below:

| Information | Description |
|---|---|
| EAS ID | Identifier of the target EAS. |
| List of EAS load | List of observed statistics or predicted analytics of the target EAS |
| analytics (1 . . . max) | load during the analytics target period. Each entry in the list |
| | corresponds to a data analytics result associated with a subset |
| | within the analytics target period. |
| >Analytics target | Time window within the requested analytics target period that the |
| period subset | analytics applies to. |
| >Application ID | Observed/predicted application ID(s) associated with this EAS. |
| >EAS indicators | Observed/predicted EAS load, such as the number of ACs served |
| | by the EAS, percentage of resource available at the EAS for ACs |
| | (compute, graphical compute, memory, storage), observed |
| | connection bandwidth per AC, observed response time to service |
| | AC requests, observed time EAS is available to service AC |
| | requests, etc. |
| >EAS status | Observed/predicted status of the EAS (e.g., enabled, disabled, etc.). |
| >Confidence | Confidence of this prediction. |
| (prediction only) | |
| Processed analytics | Other analytics results that are obtained according to the analytics |
| | operations defined in the request, such as average or max/min EAS |
| | load, ratio/percentage of time when the EAS load is above/below a |
| | threshold, ratio/percentage of time when the EAS is enabled, etc. |

The ADAE service may trigger actions based on the output analytics. For example, EAS load information can be included in an EAS discovery filter so that a heavily loaded EAS may be excluded from the discovery responses. The EAS load analytics may also be used to make dynamic EAS instantiation decisions, such as to trigger dynamic EAS instantiation when the existing EASs are predicted to be overloaded. The EAS load analytics may also be used for ACR planning, such as to schedule and trigger ACR before the predicted time when the EAS is going to be overloaded.

### EES Analytics

EES analytics may be used to monitor and predict the status of an EES and/or the edge platform associated with the EES. When requesting EES analytics, in addition to the information in tables above, the requestor may specify the identifier of the target EES in the request. The input data for EES analytics may be collected from the edge enabler layer, such as EES or ECS, as defined in the table below:

| Information | Description |
|---|---|
| EES ID | Identifier of the target EES. |
| EES information | Collected information of the target EES and/or the associated edge |
| | platform. |
| >Timestamp | A timestamp when the EES load information is collected. |
| >EES indicators | Information of the EES, such as the number of EASs being hosted |
| | by the EES, percentage of resource available at the EES or the |
| | associated edge platform (compute, graphical compute, memory, |
| | storage), connection bandwidth per EEC or EAS, response time to |
| | service EEC or EAS requests, time EES is available to service EEC |
| | or EAS requests, etc. |

The output analytics to be exposed by the ADAE may include statistics or predictions as defined in the table below:

| Information | Description |
|---|---|
| EES ID | Identifier of the target EES. |
| List of EES load | List of observed statistics or predicted analytics of the target EES |
| analytics (1 . . . max) | load during the analytics target period. Each entry in the list |
| | corresponds to a data analytics result associated with a subset |
| | within the analytics target period. |
| >Analytics target | Time window within the requested analytics target period that the |
| period subset | analytics applies to. |
| >EES indicators | Observed/predicted EES information, such as the number of EASs |
| | being hosted by the EES, percentage of resource available at the |
| | EES or the associated edge platform (compute, graphical compute, |
| | memory, storage), observed connection bandwidth per EEC or |
| | EAS, observed response time to service EEC or EAS requests, |
| | observed time EES is available to service EEC or EAS requests etc. |
| >Confidence | Confidence of this prediction. |
| (prediction only) | |
| Processed analytics | Other analytics results that are obtained according to the analytics |
| | operations defined in the request, such as average or max/min EES |
| | load, ratio/percentage of time when the EES load is above/below a |
| | threshold, etc. |

The ADAE service may trigger actions based on the output analytics. For example, the ECS may be notified of EES load statistics so that a heavily loaded EES may not be provisioned to new EECs. The EES load analytics may also be used for ACR planning, such as to schedule and trigger ACR from the current EES to a new EES.

### EDN Analytics

EDN analytics may be used to monitor and predict the status and resource usage of an EDN. When requesting EDN analytics, in addition to the information in the tables above, the requestor may specify the identifier of the target EDN in the request.

The input data for EDN analytics may be collected from the edge enabler layer (ECS), 5GC, or OAM, as defined in the table below:

| Information | Description |
|---|---|
| EDN identifier | Identifier of the target EDN. |
| EDN information | Collected information of the target EDN. |
| >Timestamp | A timestamp when the EDN load information is collected. |
| >EDN indicators | Information of the EDN, such as the number of active VAL users |
| | and/or sessions in the EDN, percentage of resource available in the |
| | EDN (compute, graphical compute, memory, storage), etc. Slice |
| | types or instances available within the EDN and/or their usage |
| | statistics. |
| | Number and/or types of EASs available in EDN. |
| | Number and/or types of ACs active in EDN. |

The output analytics to be exposed by the ADAE may include statistics or predictions as defined in the table below:

| Information | Description |
|---|---|
| EDN identifier | Identifier of the target EDN. |
| List of EDN load | List of observed statistics or predicted analytics of the target EDN |
| analytics (1 . . . max) | load during the analytics target period. Each entry in the list |
| | corresponds to a data analytics result associated with a subset |
| | within the analytics target period. |
| >Analytics target | Time window within the requested analytics target period that the |
| period subset | analytics applies to. |
| >EDN indicators | Observed/predicted EDN load, such as the number of active VAL |
| | users and/or sessions in the EDN, percentage of resource available |
| | in the EDN or the associated edge platform (compute, graphical |
| | compute, memory, storage), etc. |
| | Observed slice types or instances available within the EDN and/or |
| | their usage statistics. |
| | Observed number and/or types of EASs available in EDN. |
| | Observed number and/or types of ACs active in EDN. |
| >Confidence | Confidence of this prediction. |
| (prediction only) | |
| Processed analytics | Other analytics results that are obtained according to the analytics |
| | operations defined in the request, such as average or max/min EDN |
| | load, ratio/percentage of time when the EDN load is above/below a |
| | threshold, service availability of the EDN, etc. |

Similar to EAS and EES analytics, EDN analytics may be used to make decisions on ACR across different EDNs, such as to trigger and schedule the ACR from an overloaded EDN to a lightly loaded EDN.

### Network Slice Analytics

Network slice analytics may be used by the NSCE server to make decisions on slice adaptation, such as to determine whether to assign additional ACs and EASs to certain existing slices or allocate new slices. When requesting network slice analytics, in addition to the information in the tables above, the requestor may specify the identifier of the target network slice in the request.

The input data for network slice adaptation analytics may be collected from the service enabler layer, the edge enabler layer, 5GC, or OAM, as defined in the table below:

| Information | Description |
|---|---|
| Slice ID | Identifier of the target network slice |
| Slice information | Collected network slice information. |
| >Timestamp | A timestamp when the slice information is collected. |
| >VAL user information | The number and types of VAL users (VAL clients and VAL |
| | servers) using the slice and the corresponding KPIs. |
| >Session information | The number and types of VAL sessions using the slice and the |
| | corresponding KPIs. |

The output analytics to be exposed by the ADAE may include statistics or predictions as defined in the table below:

| Information | Description |
|---|---|
| Slice ID | Identifier of the target network slice |
| List of network slice | List of observed statistics or predicted analytics of the target |
| analytics (1 . . . max) | network slice during the analytics target period. Each entry in the |
| | list corresponds to a data analytics result associated with a subset |
| | within the analytics target period. |
| >Analytics target | Time window within the requested analytics target period that the |
| period subset | analytics applies to. |
| >VAL user information | Observed/predicted number and types of VAL users (VAL clients |
| | and VAL servers) using the slice and the corresponding KPIs. |
| >Session information | Observed/predicted number and types of VAL sessions using the |
| | slice and the corresponding KPIs. |
| >Confidence | Confidence of this prediction. |
| (prediction only) | |
| Processed analytics | Other analytics results that are obtained according to the analytics |
| | operations defined in the request, such as average or max/min |
| | number of users, ratio/percentage of time when the KPI is |
| | above/below a threshold, etc. |

### Network Exposure Analysis

Network exposure analytics may be used to monitor the CN-exposed API accesses, such as applications accessing CN services via SCEF, NEF, or PCF, and track information of these API calls in the system. Network exposure analytics may be defined as CAPIF API calls in the context of CAPIF. These analytics may be expanded further to other CAPIF API calls.

When requesting network exposure analytics, in addition to the information in the tables above, the requestor may specify the identifier of the target exposure NF in the request. The requestor may further specify other filter information such as the service area, service provider ID, API ID type, such as device triggering, session QoS configuration, UE location monitoring, etc.

The input data for network exposure analytics may be collected from the service enabler layer, 5GC, or OAM, as defined in the table below:

| Information | Description |
|---|---|
| NF ID | Identifier of the target exposure NF (e.g., NEF, SCEF, etc.) |
| Filter information | Specifies filter information for collecting network exposure |
| | information, such as geographical area or service provider ID or |
| | the invoker, API ID or type, etc. |
| Exposure information | Collected network exposure API invocation information. The |
| | following information may be collected per exposure NF ID or per |
| | geographical area or service provider ID of the invoker, API ID or, |
| | CN function type(s) accessed via exposure NF, or type, etc. |
| >Timestamp | A timestamp when the exposure information is collected. |
| >API calls | List of API calls made at the timestamp. |
| >>API ID or type | The type of accessed API. The APIs may include those exposed by |
| | SCEF/NEF, PCF. The API ID or type may reference a specific API |
| | or group of APIs. |
| >>Target information | Description of the API invocation target. The target for which the |
| | API is invoked may be a specific UE, UE type, area (e.g., how |
| | many UEs in a certain area. ), CN NF. |
| >>Requestor | Information of the API requestor, including identifier, service |
| information | provider, location, corresponding EDN, DNAI, etc. The requestor |
| | information also includes service level information such as vertical |
| | application type, App ID, etc. |

The output analytics to be exposed by the ADAE may include statistics or predictions as defined in the table below:

| Information | Description |
|---|---|
| NF ID | Identifier of the target exposure NF (e.g., NEF, SCEF, etc.) |
| Filter information | Filter information that specifies where the analytics may apply, |
| | such as area of coverage, service provider ID, API ID type, etc. |
| Exposure analytics | List of statistics or predictions of the target exposure NF during the |
| (1 . . . max) | analytics target period. The following information may be |
| | applicable per NF ID or per area of coverage, service provider ID, |
| | API ID type, etc. Each entry in the list corresponds to a data |
| | analytics result associated with a subset within the analytics target |
| | period. |
| >Analytics target | Time window within the requested analytics target period that the |
| period subset | analytics applies to. |
| >API calls | Observed/predicted list of API calls made during this time slot. |
| >>API ID or type | Observed/predicted type of accessed API. The APIs may include |
| | those exposed by SCEF/NEF, PCF. The API ID or type may |
| | reference a specific API or group of APIs. For example, device |
| | triggering, session QoS configuration, UE location monitoring. |
| >>Target information | Observed/predicted API invocation target, such as a specific UE, |
| | UE type, area (e.g., how many UEs in a certain area.). |
| >>Requestor | Observed/predicted API requestor and the corresponding |
| information | information, which may include the identifier, service provider, |
| | location, corresponding EDN, DNAI, etc .. The requestor |
| | information also includes service level information such as vertical |
| | application type, etc. |
| >Confidence | Confidence of this prediction. |
| (prediction only) | |
| Processed analytics | Other analytics results that are obtained according to the analytics |
| | operations defined in the request, such as average or max/min |
| | number of API calls during the analytics period, the most |
| | accessed/popular API, etc. |
| NWDAF analytics | The container storing information from notifications resulting from |
| exposure container | NWDAF analytics exposure API calls for further exposure to the |
| | ADAE. |

### Off-Network Analytics

Off-network analytics may be used to collect information and generate analytics for off-network communications between ADAE clients and other service enabler clients. When requesting off-network analytics, in addition to the information in the table below, the requestor may specify the identifier of the target UE in the request.

The input data for off-network analytics may be collected from the service enabler layer, the edge enabler layer, 5GC, or OAM, as defined in the table below:

| Information | Description |
|---|---|
| UE (group) ID | Identifier of the target UE (and/or a corresponding group). |
| Connection information | Collected information of the off-network connection(s) during the |
| | data collection period, including client endpoints, establishment |
| | timing/duration, link quality, location/area, EDN, area or local |
| | network, connectivity type. The connection information may refer |
| | to 3GPP specified and controlled links (e.g. PC5), other access |
| | networks used by 5GS (e.g. WiFi), or access networks external to |
| | 5GS. |
| Service layer | Service layer information associated with the off-network |
| information | connection, e.g., service layer interactions, involved service layer |
| | entities, VAL services, service layer IDs, etc. |
| Device and topology | Information associated with the topology of the off-network |
| information | connection(s) and the associated nodes or devices. This includes |
| | information related to multiple-hop topologies. It also includes |
| | device-related information including type, battery level, memory |
| | and compute capabilities, etc. |

The output analytics to be exposed by the ADAE may include statistics or predictions as defined in the table below:

| Information | Description |
|---|---|
| UE (group) ID | Identifier of the target UE (and/or a corresponding group). |
| Connection information | Observed/predicted information of the off-network connection(s) |
| | during the analytics period, including client endpoints, |
| | establishment timing/ duration, link quality, location/area, EDN, |
| | area or local network, connectivity type. The connection |
| | information may refer to 3GPP specified and controlled links (e.g. |
| | PC5), other access networks used by 5GS (e.g. WiFi), or access |
| | networks external to 5GS. |
| Service layer | Observed/predicted service layer information associated with the |
| information | off-network connection(s), e.g., service layer interactions, involved |
| | service layer entities, VAL services, service layer IDs, etc. |
| Device and topology | Observed/predicted information associated with the topology of the |
| information | off-network connection(s) and the associated nodes or devices. This |
| | includes information related to multiple-hop topologies. It also |
| | includes device-related information including type, battery level, |
| | memory and compute capabilities, etc. |
| Confidence (prediction | Confidence of this prediction. |
| only) | |
| Processed analytics | Other analytics results that are obtained according to the analytics |
| | operations defined in the request, such as average or max/min |
| | number of off-network connections established by the target UE, |
| | recommended target endpoint to establish off-network connection, |
| | etc. |

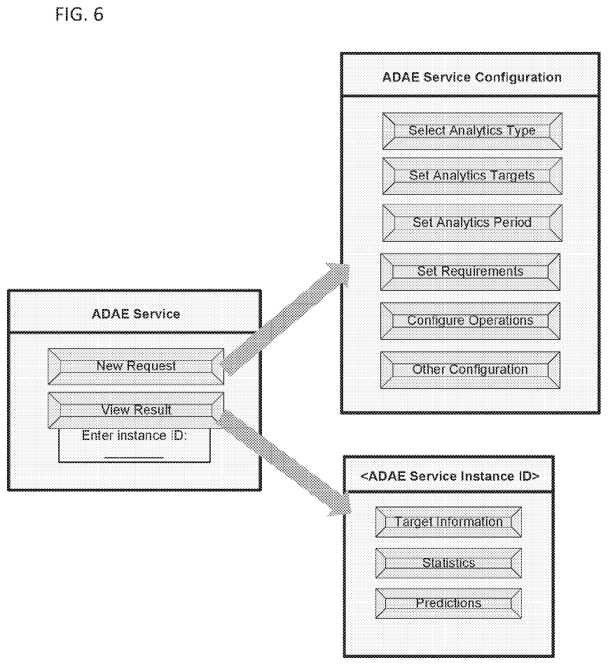

FIG. 6 shows an example Graphical User interface to request ADAE service and view the analytics result.

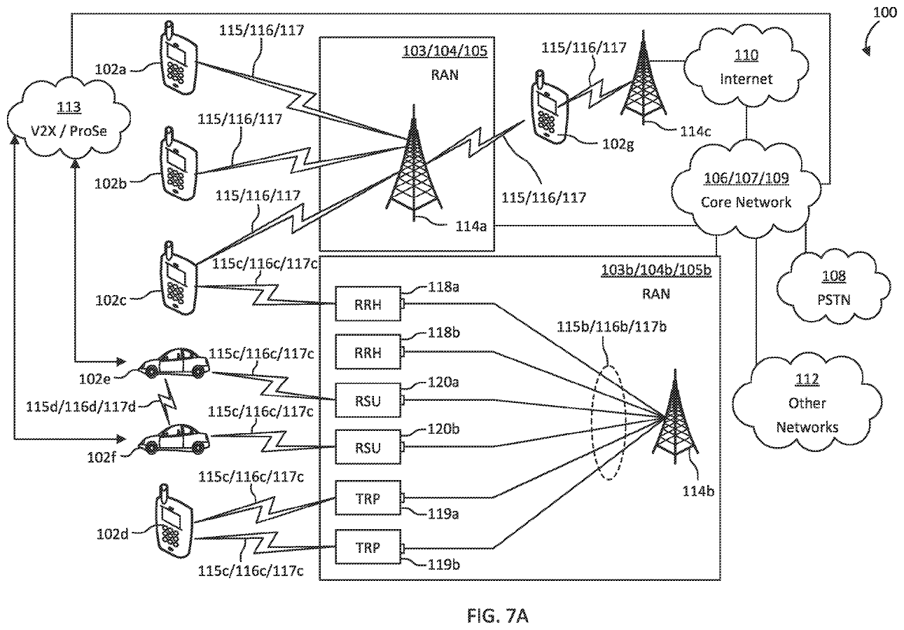

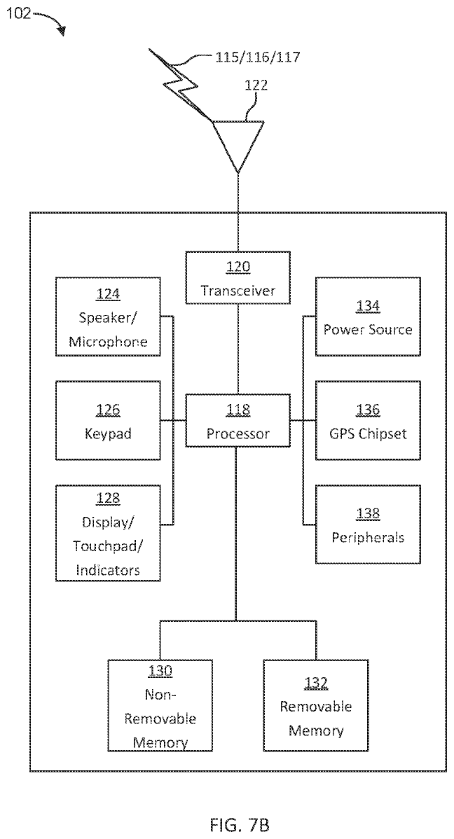

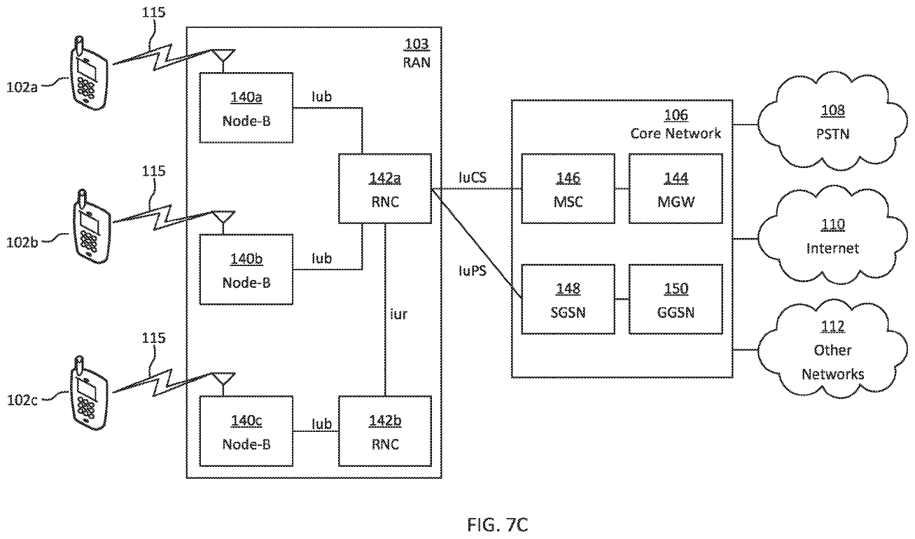

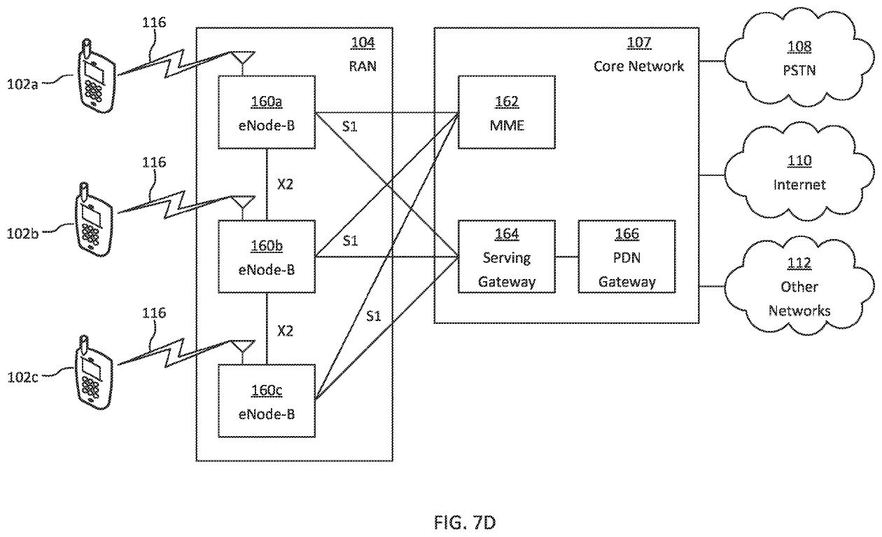

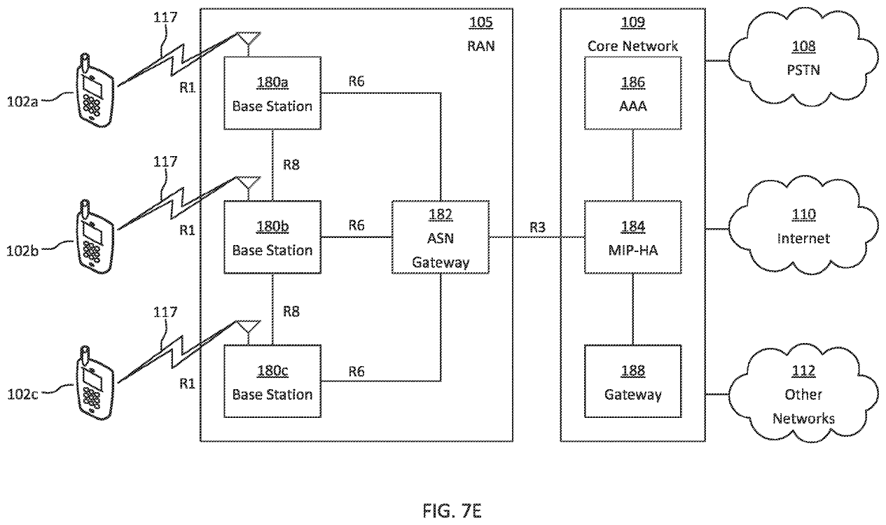

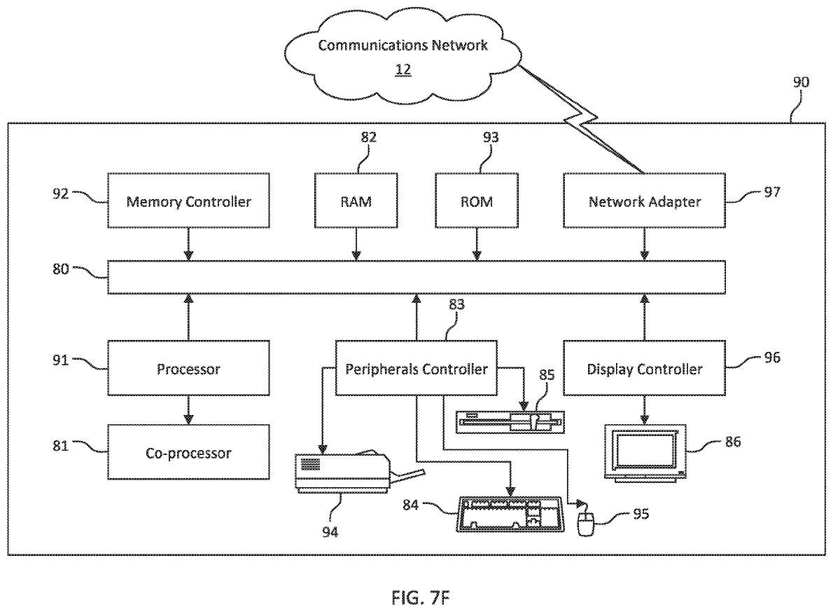

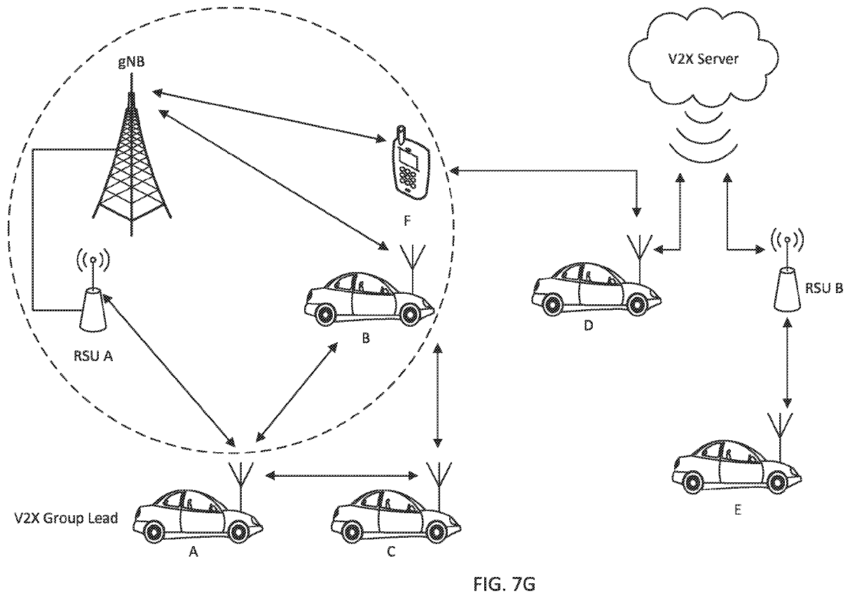

FIG. 7A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 7A-7E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 7A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 7A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 7A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 7A may be configured to communicate with the base station 114a, which may employ a cellular-based radio technology, and with the base station 114c, which may employ an IEEE 802 radio technology.

FIG. 7B is a block diagram of an example apparatus or device configured for wireless communications in accordance with the embodiments illustrated herein, such as for example, a WTRU 102. As shown in FIG. 7B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 7B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 7B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 7B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 7C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 7C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 7C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 7C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 7D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 7D, the eNode-Bs 160a, 160b, 160c may communicate with one another over an X2 interface.

The core network 107 shown in FIG. 7D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 7E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 7E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QOS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 7E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 7E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 7A, 7C, 7D, and 7E are identified by the names given to those entities in certain existing 3GPP specifications, but it is understood that in the future those entities and functionalities may be identified by other names and certain entities, or functions may be combined in future specifications published by 3GPP, including future 3GPP NR specifications. Thus, the particular network entities and functionalities described and illustrated in FIGS. 7A, 7B, 7C, 7D, and 7E are provided by way of example only, and it is understood that the subject matter disclosed and claimed herein may be embodied or implemented in any similar communication system, whether presently defined or defined in the future.

FIG. 7F is a block diagram of an exemplary computing system 90 in which one or more apparatuses of the communications networks illustrated in FIGS. 7A, 7C, 7D and 7E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 7A, 7B, 7C, 7D, and 7E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 7G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. An apparatus providing a service enablement layer analytics service in a cellular network:
receiving, from an analytics service consumer, a service enablement layer data analytics request, wherein the request includes requirements of the analytics service;
determining, based on the service enablement layer analytics request, to collect data from a service layer server;
sending, to the determined service layer server, a request to collect server-side service enablement layer data related to the service enablement layer analytics request;
receiving, from the determined service layer server, the server-side service enablement layer data related to the service enablement layer data analytics request;
determining, based on the service enablement layer analytics request, to collect data from a service layer client;
sending, to the determined service layer client, a request to collect client-side service enablement layer data related to the service enablement layer analytics;
receiving, from the determined service layer client, the client-side service enablement layer data related to the service enablement layer data analytics request;
generating analytics result based on the received server-side data, the received client-side data and the requirements of the analytics service; and
sending, to the analytics service consumer, a response indicating the analytics result.

2. The apparatus recited in claim 1, wherein the analytics service consumer is an application server or a service enablement layer server.

3. The apparatus recited in claim 1, wherein the analytics request further includes one or more of an analytics type, identifier(s) of one or more analytics targets, analytics filter information, area of interest.

4. The apparatus recited in claim 1, wherein the analytics request is a subscription request.

5. The apparatus recited in claim 1, wherein the apparatus further collects data from another entity capable of providing analytics service.

6. The apparatus recited in claim 1, wherein the analytics result includes predictions and the corresponding confidence levels.

7. The apparatus recited in claim 1, wherein the analytics request is related to application performance.

8. The apparatus recited in claim 1, wherein the analytics request is related to edge data network.

9. The apparatus recited in claim 1, wherein the analytics request is related to network slice.

10. The apparatus recited in claim 1, wherein the analytics request is related to accesses of services or functions.

11. A method for providing a service enablement layer analytics service in a cellular network, comprising:
receiving, from an analytics service consumer, a service enablement layer data analytics request, wherein the request includes requirements of the analytics service;
determining, based on the service enablement layer analytics request, to collect data from a service layer server;
sending, to the determined service layer server, a request to collect server-side service enablement layer data related to the service enablement layer analytics request;
receiving, from the determined service layer server, the server-side service enablement layer data related to the service enablement layer data analytics request;
determining, based on the service enablement layer analytics request, to collect data from a service layer client;
sending, to the determined service layer client, a request to collect client-side service enablement layer data related to the service enablement layer analytics;
receiving, from the determined service layer client, the client-side service enablement layer data related to the service enablement layer data analytics request;
generating analytics result based on the received server-side data, the received client-side data and the requirements of the analytics service; and
sending, to the analytics service consumer, a response indicating the analytics result.

12. The method recited in claim 11, wherein the analytics service consumer is an application server or a service enablement layer server.

13. The method recited in claim 11, wherein the analytics request further includes one or more of an analytics type, identifier(s) of one or more analytics targets, analytics filter information, area of interest.

14. The method recited in claim 11, wherein the analytics request is a subscription request.

15. The method recited in claim 11, wherein the apparatus further collects data from another entity capable of providing analytics service.

16. The method recited in claim 11, wherein the analytics result includes predictions and the corresponding confidence levels.

17. The method recited in claim 11, wherein the analytics request is related to application performance.

18. The method recited in claim 11, wherein the analytics request is related to edge data network.

19. The method recited in claim 11, wherein the analytics request is related to network slice.

20. The method recited in claim 11, wherein the analytics request is related to accesses of services or functions.
